(19) United States
(12) Patent Application Publication
(10) Pub. No.: US 2022/0058494 A1
(43) Pub. Date: Feb. 24, 2022

(54) HYBRID ENSEMBLE MODEL LEVERAGING EDGE AND SERVER SIDE INFERENCE

(71) Applicant: International Business Machines Corporation, Armonk, NY (US)

(72) Inventors: Jing Wu, Xian (CN); Hong Bing Zhang, Beijing (CN); Fan Li, Xianyang (CN); Yong Wang, Xi'an (CN); Dan Zhang, Beijing (CN)

(21) Appl. No.: 16/998,061

(22) Filed: Aug. 20, 2020

(51) Int. Cl. G06N 5/04; G06N 20/20; G06K 9/32; G06F 16/2458

(52) U.S. Cl. CPC G06N 5/04; G06N 20/20; G06F 2216/03; G06F 16/2465; G06K 9/3233

(57) ABSTRACT

In an approach for a hybrid ensemble model leveraging edge and server side inference, a processor receives data on an edge device. A processor sends the data to a server. A processor performs, in parallel, inference on the data using a first model on the edge device and a second model on the server. A processor returns a result of the second model to the edge device. A processor ensembles, on the edge device, a result of the first model and the result of the second model based on a set of weights to produce an ensembled result. A processor outputs the ensemble result for a user to view through a user interface of the edge device.

### BACKGROUND

The present invention relates generally to the field of model inference, and more particularly to a hybrid ensemble model leveraging edge-side and server-side inference.

Edge computing is transforming the way data is being handled, processed, and delivered with the explosive growth of internet-connected devices—the IoT—along with new applications that require real-time computing power, continues to drive edge-computing systems. Edge computing can be defined as “a part of a distributed computing topology in which information processing is located close to the edge where things and people produce or consume that information.” At its basic level, edge computing brings computation and data storage closer to the devices where it's being gathered, rather than relying on a central location that can be thousands of miles away.

Edge computing was developed due to the exponential growth of IoT devices, which connect to the internet for either receiving information from the cloud or delivering data back to the cloud. While early goals of edge computing were to address the costs of bandwidth for data traveling long distances because of the growth of IoT-generated data, the rise of real-time applications that need processing at the edge will drive the technology ahead. Edge-computing hardware and services help solve this problem by being a local source of processing and storage.

Increasingly, though, the biggest benefit of edge computing is the ability to process and store data faster, enabling for more efficient real-time applications that are critical to companies. Before edge computing, a smartphone scanning a person's face for facial recognition would need to run the facial recognition algorithm through a cloud-based service, which would. take a lot of time to process. With an edge computing inference model, the facial recognition model could run locally on an edge server or gateway, or even on the smartphone itself, given the increasing power of smartphones.

### SUMMARY

Aspects of an embodiment of the present invention disclose a method, computer program product, and computer system for a hybrid model ensemble leveraging edge and server side inference. A processor receives data on an edge device. A processor sends the data to a server. A processor performs, in parallel, inference on the data using a first model on the edge device and a second model on the server, A processor returns a second model result of the second model to the edge device. A processor ensembles, on the edge device, a first model result of the first model and the second model result of the second model based on a set of weights to produce an ensembled result. A processor outputs the ensemble result for a user to view through a user interface of the edge device.

In some aspects of an embodiment of the present invention, the data is a photo taken by the user of the edge device and the inference performed on the photo is object recognition.

In some aspects of an embodiment of the present invention, a processor determines a first weight of the set of weights to be applied to the result of the first model based on a data mining analysis method of first prior knowledge data of the edge device and determines a second weight of the set of weights to be applied to the result of the second model based on the first weight. In these embodiments, the first prior knowledge data is data collected on the edge device associated with a user of the edge device; the first prior knowledge data comprises historical behavior trends, environmental influences, and personalized information about the first model, the user, and a type of inference occurring; and the data mining analysis method is selected from the group consisting of cluster analysis, correlation analysis, regression analysis, and classification prediction.

### BRIEF DESCRIPTION OF THE DRAWINGS

FIG. 1 depicts a block diagram of a distributed data processing environment, in accordance with an embodiment of the present invention.

FIG. 2 depicts a flowchart of the steps of an ensemble inference program, for leveraging server-side and edge-side inference in a hybrid ensemble model, in accordance with an embodiment of the present invention.

FIG. 3 depicts a block diagram of a computing device of the distributed data processing environment, in accordance with an embodiment of the present invention.

### DETAILED DESCRIPTION

Embodiments of the present invention recognize that, for deep learning, model inference can be executed on the server side or on an edge device with speed and precision being the two most important factors for evaluating model performance and deciding which side the model inference should be performed on. From a precision consideration, server-side inference is more widely used, and therefore, current solutions for model optimization focus on the server-side model.

In an example embodiment of an existing solution using server-side inference for object recognition, responsive to a user taking a photo on a mobile device of a traffic sign, the photo is uploaded to a server for inference using an object recognition model. Then, the server returns the output inference from the object recognition model to the mobile device, so the user can view the result.

Currently, model performance can be optimized by optimizing the single model using the model itself, but it is hard to optimize the single model continuously. Ensemble learning, or running two or more models, on the server-side can also be used to optimize model performance. Ensemble learning uses at least two models on the server-side, which is a simple but useful method for optimization because different models can be complementary.

The downfall with ensemble learning is that resource consumption is doubled, which is why the application of ensemble learning in a real-world project is limited. For example, when using ensemble models on the server-side, serial inference or multi-threading parallel inference can be adopted. Serial inference of a single process takes up a lot of time; and therefore, in the case of ensemble models, which have different models always queued up for model inference and then have to assemble the results, the serial operation mechanism leads to the accumulation of the overall model inference time. Multi-threading parallel inference for models also takes up a lot of a server's process resources. Therefore, ensemble learning using multiple models on the server-side increases a time cost and a resource cost.

Embodiments of the present invention provide a system and method for ensembling results from an edge-side model and server-side model to provide inferences without increasing time and resource costs. Embodiments of the present invention execute model inference simultaneous in parallel on the server-side and on an edge device, i.e., the user's device, upon arrival of the user's request. Embodiments of the present invention ensemble the results from the server-side model and the edge-side model using a hybrid ensemble model. Embodiments of the present invention dynamically adjust weights of each model during the ensemble process to improve performance.

Embodiments of the present invention are easy to implement in a real-world project without increasing cost, i.e., time and resources, while improving precision of the result, because although model inference is done twice on two separate models, the model inference is done in parallel at the same time on the two separate devices. Generally, the extra step of ensembling the results from the edge side and the server side is diminutive timewise compared with a single model inference time.

The present invention may contain various accessible data sources, such as server 110 and edge device 120, that may include personal data, content, or information the user wishes not to be processed. Personal data includes personally identifying information or sensitive personal information as well as user information, such as tracking or geolocation information. Processing refers to any, automated or unautomated, operation or set of operations such as collection, recording, organization, structuring, storage, adaptation, alteration, retrieval, consultation, use, disclosure by transmission, dissemination, or otherwise making available, combination, restriction, erasure, or destruction performed on personal data. Ensemble inference program 112 enables the authorized and secure processing of personal data. Ensemble inference program 112 provides informed consent, with notice of the collection of personal data, allowing the user to opt in or opt out of processing personal data.

Consent by a user can take several forms. Opt-in consent can impose on the user to take an affirmative action before personal data is processed. Alternatively, opt-out consent can impose on the user to take an affirmative action to prevent the processing of personal data before personal data is processed. Ensemble inference program 112 provides information regarding personal data and the nature (e.g., type, scope, purpose, duration, etc.) of the processing. Ensemble inference program 112 provides the user with copies of stored personal data. Ensemble inference program 112 allows the correction or completion of incorrect or incomplete personal data. Ensemble inference program 112 allows the immediate deletion of personal data.

The present invention will now be described in detail with reference to the Figures.

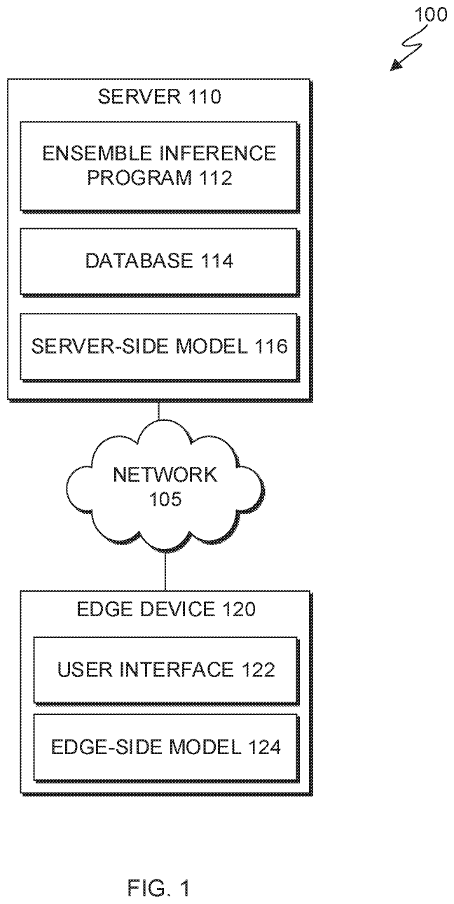

FIG. 1 depicts a functional block diagram illustrating distributed data processing environment 100, in accordance with an embodiment of the present invention. The term “distributed” as used herein describes a computer system that includes multiple, physically distinct devices that operate together as a single computer system. FIG. 1 provides only an illustration of one embodiment of the present invention and does not imply any limitations with regard to the environments in which different embodiments may be implemented. Many modifications to the depicted environment may be made by those skilled in the art without departing from the scope of the invention as recited by the claims.

In the depicted embodiment, distributed data processing environment 100 includes server 110 and edge device 120 interconnected over network 105. In an embodiment, distributed data processing environment 100 represents a system for a hybrid ensemble model leveraging edge-side and server-side inference. Network 105 can be, for example, a local area network (LAN), a wide area network (WAN) such as the Internet, or a combination of the two, and can include wired, wireless, or fiber optic connections. Network 105 can include one or more wired and/or wireless networks that are capable of receiving and transmitting data, voice, and/or video signals, including multimedia signals that include voice, data, and video information. In general, network 105 can be any combination of connections and protocols that will support communications between server 110 and edge device 120. Distributed data processing environment 100 may include additional servers, computers, or other devices not shown.

Server 110 operates to run ensemble inference program 112, manage database 114, and run server-side model 116. In the depicted embodiment, server 110 contains ensemble inference program 112, database 114, and server-side model 116. In an embodiment, server 110 acts as a server-side component of ensemble inference program 112 for completing model inference using server-side model 116.

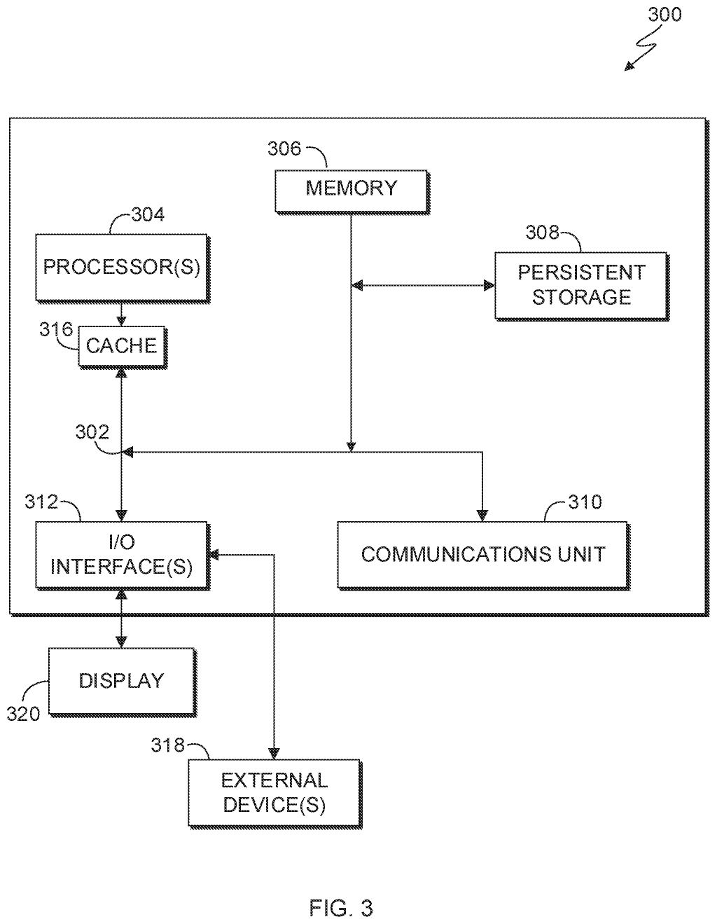

In some embodiments, server 110 can be a standalone computing device, a management server, a web server, or any other electronic device or computing system capable of receiving, sending, and processing data and capable of communicating with computing device 120 via network 105. In other embodiments, server 110 represents a server computing system utilizing multiple computers as a server system, such as a cloud computing environment. In yet other embodiments, server 110 represents a computing system utilizing clustered computers and components (e.g., database server computers, application server computers, etc.) that act as a single pool of seamless resources when accessed within distributed data processing environment 100. Server 110 may include components as described in further detail in FIG. 3.

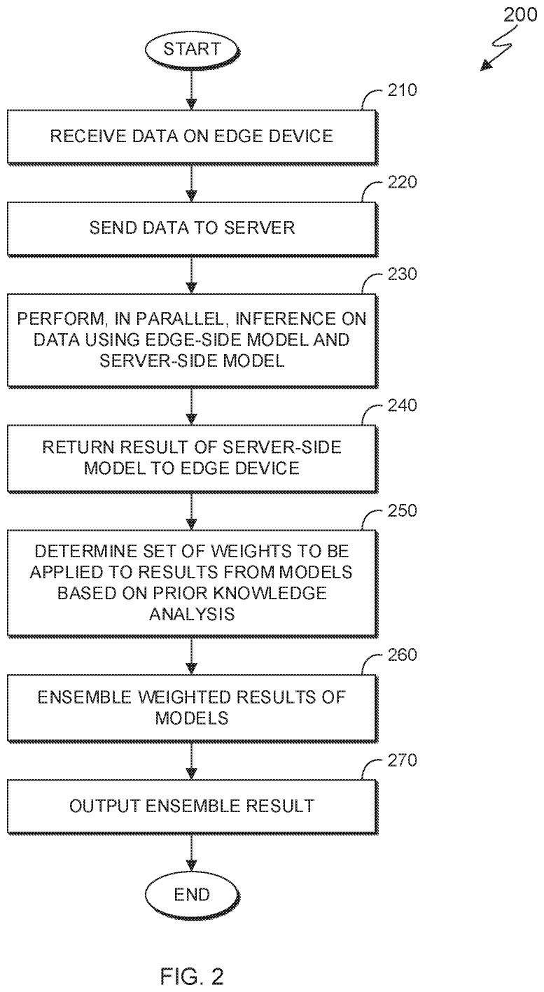

Ensemble inference program 112 operates to leverage server-side and edge-side inference in a parallel ensemble model. In the depicted embodiment, ensemble inference program 112 resides on server 110 with user interface 122 being a local app interface of ensemble inference program 112 running on edge device 120. In an embodiment, ensemble inference program 112 has server-side processes, e.g., server-side model 116, and edge-side processes, e.g., edge-side model 124. In an embodiment, certain steps of ensemble inference program 112 are run on server 110 and other steps of ensemble inference program 112 are run on edge device 120 provided that ensemble inference program 112 has access to network 105 to exchange information between server 110 and edge device 120. Ensemble inference program 112 is described in more detail below with reference to FIG. 2.

Database 114 operates as a repository for data received, used, and/or output by ensemble inference program 112. Data received, used, and/or generated may include, but is not limited to, photo and corresponding photo data; inference data output by server-side model 116 and edge-side model 1124; and any other data received, used, and/or output by ensemble inference program 112. Database 114 can be implemented with any type of storage device capable of storing data and configuration files that can be accessed and utilized by server 110, such as a hard disk drive, a database server, or a flash memory. In an embodiment, database 114 is accessed by server 110, ensemble inference program 112, and/or edge device 120 to store and/or to access the data. In the depicted embodiment, database 114 resides on server 110. In another embodiment, database 114 may reside on another computing device, server, cloud server, or spread across multiple devices elsewhere (not shown) within distributed data processing environment 100, provided that database 114 has access to network 105.

Edge device 120 operates as an edge computing device that can send and receive data through a user interface. In an embodiment, edge device 120 acts as an edge-side component of ensemble inference program 112 for completing model inference using edge-side model 116. In the depicted embodiment, edge device 120 includes an instance of user interface 122 and edge-side model 124.

In some embodiments, edge device 120 may be, but is not limited to, an electronic device, such as a laptop computer, a tablet computer, a netbook computer, a personal computer (PC), a desktop computer, a smart phone, a wearable computing device, or any programmable electronic device capable of running user interface 122 and communicating (i.e., sending and receiving data) with server 110 and/or ensemble inference program 112 via network 105. In some embodiments, edge device 120 represents one or more programmable electronic devices or combination of programmable electronic devices capable of executing machine readable program instructions and communicating with server 110 and/or other computing devices within distributed data processing environment 100 via a network, such as network 105. In an embodiment, edge device 120 represents one or more devices associated with one or more users. Edge device 120 may include components as described in further detail in FIG. 3.

User interface 122. operates as a local app user interface on edge device 120 of ensemble inference program 112 through which one or more users of edge device 120 interact with ensemble inference program 112 on edge device 120. In some embodiments, user interface 122 is a graphical user interface (GUI), a web user interface (WUI), and/or a voice user interface (VUI) that can display (i.e., visually), present (i.e., audibly), and/or enable a user to enter or receive information (i.e., graphics, text, and/or sound) for or from ensemble inference program 112 via network 105. In an embodiment, user interface 122 enables a user to send and receive data (i.e., to and from ensemble inference program 112 via network 105, respectively). In an embodiment, user interface 122 enables a user to take a photo and upload the photo to ensemble inference program 112 for model inference, e.g., image classification. In an embodiment, user interface 122 enables a user to view an ensembled result of the model inference.

FIG. 2 depicts a flowchart 200 of the steps of ensemble inference program 112, for leveraging server-side and edge-side inference into a hybrid parallel ensemble model, in accordance with an embodiment of the present invention. In an embodiment, ensemble inference program 112 receives data on an edge device, sends the data to a server, performs, in parallel, inference on data using a first model on edge device and a second model on server, returns a result of the second model to the edge device, ensembles the result of the second model and a result of the first model into an ensembled result, and outputs the ensembled result. It should be appreciated that the process depicted in FIG. 2 illustrates one possible iteration of ensemble inference program 112 that may be repeated.

In step 210, ensemble inference program 112 receives data on edge device. In an embodiment, ensemble inference program 112 receives data on an edge device. In some embodiments, ensemble inference program 112 receives data input by a user through user interface 122 of edge device 120. In other embodiments, ensemble inference program 112 receives data stored in a local database on edge device 120. For example, ensemble inference program 112 receives a photo taken on a mobile device by a user of the mobile device. In this example, a user of edge device 120 can either open the local app of ensemble inference program 112 and then take the photo or the user can take the photo and then upload it to the local app of ensemble inference program 112 on edge device 120.

In step 220, ensemble inference program 112 sends the data to server. In an embodiment, ensemble inference program 112 sends the data from the edge device to a server, e.g., server 110. In an embodiment, ensemble inference program 112 sends the data received on the edge device to a server running the server-side of ensemble inference program 112. Continuing the photo example, ensemble inference program 112 sends or uploads the photo to server 110. In some embodiments, responsive to ensemble inference program 112 receiving data on the edge device, e.g., edge device 120, ensemble inference program 112 sends the data to the server, e.g., server 110.

In step 230, ensemble inference program 112 performs, in parallel, inference on the data using an edge-side model on the edge device and a server-side model on the server. In an embodiment, ensemble inference program 112 performs, in parallel, inference on the data using an edge-side model on the edge device and a server-side model on the server. For example, ensemble inference program 112 performs, in parallel, inference on the data using edge-side model 124 on edge device 120 and server-side model 116 on server 110. In an embodiment, ensemble inference program 112 simultaneously performs, in parallel, inference on the data using an edge-side model on the edge device and a server-side model on the server. In an embodiment, responsive to ensemble inference program 112 sending the data to the server, ensemble inference program 112 performs, in parallel, inference on the data using an edge-side model on the edge device and a server-side model on the server. For example, ensemble inference program 112 performs, in parallel, object identification on a photo taken on edge device 120 using edge-side model 124 on edge device 120 and server-side model 116 on server 110.

In step 240, ensemble inference program 112 returns a result of the server-side model to the edge device. In an embodiment, ensemble inference program 112 returns a result of the server-side model to the edge device. For example, ensemble inference program 112 returns a result of the object identification performed on a photo by server-side model 116 on server 110 to edge device 120. In an embodiment, responsive to ensemble inference program 112 performing inference on the data using the edge-side model and the server-side model, ensemble inference program 112 returns a result of the server-side model to the edge device.

In step 250, ensemble inference program 112 determines a set of weights to be applied to the results from the edge-side model and the server-side model based on prior knowledge analysis. In an embodiment, ensemble inference program 112 determines a first weight to be applied to the result from the edge-side model on the edge device and a second weight to be applied to the result from the server-side model on the server based on a data mining analysis, e.g., cluster analysis, correlation analysis, regression analysis, or classification prediction, of prior knowledge data corresponding to the edge-side model. In an embodiment, responsive to ensemble inference program 112 returning the result of the server-side model to the edge device, ensemble inference program 112 determines a set of weights to be applied to the results from the edge-side model and the server-side model based on prior knowledge analysis.

In an embodiment, ensemble inference program 112 analyzes prior knowledge data for the edge-side model using a data mining analysis method, in which prior knowledge data is data collected on the edge device associated with a user of the edge device. Data collected on the edge device includes, but is not limited to, historical behavior trends, environmental influences, and/or personalized information about the model, the user, and/or the type of inference occurring. For example, if model A is good at detecting disease X and model B is good at detecting disease Y and a female individual is more likely to have disease X, ensemble inference program 112 applies this prior knowledge as a weight to model A.

In an embodiment, based on the prior knowledge analysis, ensemble inference program 112 determines a first weight for the edge-side model as a value (w) between zero (0) and one (1). In an embodiment, responsive to ensemble inference program 112 determining a first weight for the edge-side model, ensemble inference program 112 determines a second weight for the server-side model as a value of 1−w.

In step 260, ensemble inference program 112 ensembles, on the edge device, weighted results of the models. In an embodiment, ensemble inference program 112 ensembles (i.e., combines), on the edge device, the result of the second model with a result of the first model into an ensembled result, in an embodiment, responsive to ensemble inference program 112 determining the set of weights to be applied to the results from the edge-side model and the server-side model based on the prior knowledge analysis, ensemble inference program 112 ensembles the weighted results of the models.

In an embodiment, ensemble inference program 112 uses an ensemble model to combine the result from the first model and the result from the second model. In an embodiment, ensemble inference program 112 inputs the result from the first model, the result from the second model, and prior knowledge data into the ensemble model. In an embodiment, ensemble inference program 112 utilizes the ensemble model to dynamically adjust the set of weights to be applied to the results from the models. In an embodiment, ensemble inference program 112 applies the first weight to the result from the first model to produce a first weighted result and applies the second weight to the result from the second model to produce a second weighted result. In an embodiment, ensemble inference program 112 ensembles the first weighted result and the second weighted result to produce an ensembled result. Equation (1) can be used to apply a weight to each result, in which the weight w is a function of the prior knowledge data.

ƒ=wƒ_{A}+(1−w)ƒ_{b}→ƒ=w(U)ƒ_{A}+(1−w(U))ƒ_{b} (1)

In step 270, ensemble inference program 112 outputs the ensembled result. In an embodiment, ensemble inference program 112 outputs, on the edge device, the ensembled result. In an embodiment, ensemble inference program 112 outputs the ensembled result for a user to view through a user interface, e.g., user interface 122 on edge device 120. In an embodiment, responsive to ensemble inference program 112 ensembling the weighted results of the models, ensemble inference program 112 outputs the ensembled result.

FIG. 3 depicts a block diagram of components of computing device 300 suitable for server 110 and/or edge device 120 in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Computing device 300 includes communications fabric 302, which provides communications between cache 316, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses or a crossbar switch.

Memory 306 and persistent storage 308 are computer readable storage media. In this embodiment, memory 306 includes random access memory (RAM). In general, memory 306 can include any suitable volatile or non-volatile computer readable storage media. Cache 316 is a fast memory that enhances the performance of computer processor(s) 304 by holding recently accessed data, and data near accessed data, from memory 306.

Programs may be stored in persistent storage 308 and in memory 306 for execution and/or access by one or more of the respective computer processors 304 via cache 316. In an embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices. In these examples, communications unit 310 includes one or more network interface cards. Communications unit 310 may provide communications through the use of either or both physical and wireless communications links. Programs may be downloaded to persistent storage 308 through communications unit 310.

I/O interface(s) 312 allows for input and output of data with other devices that may be connected to server 110 and/or edge device 120. For example, I/O interface 312 may provide a connection to external devices 318 such as a keyboard, keypad, a touch screen, and/or some other suitable input device. External devices 318 can also include portable computer readable storage media such as, for example, thumb drives, portable optical or magnetic disks, and memory cards. Software and data used to practice embodiments of the present invention can be stored on such portable computer readable storage media and can be loaded onto persistent storage 308 via I/O interface(s) 312. I/O interface(s) 312 also connect to a display 320.

Display 320 provides a mechanism to display data to a user and may be, for example, a computer monitor.

Programs described herein is identified based upon the application for which it is implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing, device receives computer readable program instructions from the network and forwards the computer readable program instructions for storage in a computer readable storage medium within the respective computing/processing, device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
receiving data on an edge device;
sending the data to a server;
performing, in parallel, inference on the data using a first model on the edge device and a second model on the server;
returning a second model result of the second model to the edge device;
ensembling, on the edge device, a first model result of the first model and the second model result of the second model based on a set of weights to produce an ensembled result; and
outputting the ensemble result for a user to view through a user interface of the edge device.

2. The computer-implemented method of claim 1, wherein the data is a photo taken by the user of the edge device.

3. The computer-implemented method of claim 2, wherein the inference performed on the photo is object recognition.

4. The computer-implemented method of claim 1, further comprising:
determining a first weight of the set of weights to be applied to the first model result of the first model based on a data mining analysis method of first prior knowledge data of the edge device; and
determining a second weight of the set of weights to be applied to the result of the second model based on the first weight.

5. The computer-implemented method of claim 4, wherein the first prior knowledge data is data collected on the edge device associated with a user of the edge device.

6. The computer-implemented method of claim 4, wherein the first prior knowledge data comprises historical behavior trends, environmental influences, and personalized information about the first model, the user, and a type of inference occurring.

7. The computer-implemented method of claim 4, wherein the data mining analysis method is selected from the group consisting of cluster analysis, correlation analysis, regression analysis, and classification prediction.

8. A computer program product comprising:
one or more computer readable storage media and program instructions stored on the one or more computer readable storage media, the program instructions comprising:
program instructions to receive data on an edge device;
program instructions to send the data to a server;
program instructions to perform, in parallel, inference on the data using a first model on the edge device and a second model on the server;
program instructions to return a second model result of the second model to the edge device;
program instructions to ensemble, on the edge device, a first model result of the first model and the second model result of the second model based on a set of weights to produce an ensembled result; and
program instructions to output the ensemble result for a user to view through a user interface of the edge device.

9. The computer program product of claim 8, wherein the data is a photo taken by the user of the edge device.

10. The computer program product of claim 9, wherein the inference performed on the photo is object recognition.

11. The computer program product of claim 8, further comprising:
determining a first weight of the set of weights to be applied to the result of the first model based on a data mining analysis method of first prior knowledge data of the edge device; and
determining a second weight of the set of weights to be applied to the result of the second model based on the first weight.

12. The computer program product of claim 11, wherein the first prior knowledge data is data collected on the edge device associated with a user of the edge device.

13. The computer program product of claim 11, wherein the first prior knowledge data comprises historical behavior trends, environmental influences, and personalized information about the first model, the user, and a type of inference occurring.

14. The computer program product of claim 11, wherein the data mining analysis method is selected from the group consisting of cluster analysis, correlation analysis, regression analysis, and classification prediction.

15. A computer system comprising:
one or more computer processors;
one or more co pr er readable storage media;
program instructions stored on the computer readable storage media for execution by at least one of the one or more processors, the program instructions comprising:
program instructions to receive data on an edge device;
program instructions to send the data to a server;
program instructions to perform, in parallel, inference on the data using a first model on the edge device and a second model on the server;
program instructions to return a second model result of the second model to the edge device;
program instructions to ensemble, on the edge device, a first model result of the first model and the second model result of the second model based on a set of weights to produce an ensembled result; and
program instructions to output the ensemble result for a user to view through a user interface of the edge device.

16. The computer system of claim 15, wherein the data is a photo taken by the user of the edge device.

17. The computer system of claim 16, wherein the inference performed on the photo is object recognition.

18. The computer system of claim 15, further comprising:
determining a first weight of the set of weights to be applied to the result of the first model based on a data mining analysis method of first prior knowledge data of the edge device; and
determining a second weight of the set of weights to be applied to the result of the second model based on the first weight.

19. The computer system of claim 18, wherein the first prior knowledge data is data collected on the edge device associated with a user of the edge device.

20. The computer system of claim 18, wherein the first prior knowledge data comprises historical behavior trends, environmental influences, and personalized information about the first model, the user, and a type of inference occurring.
